(19) United States
(12) Patent Application Publication
(10) Pub. No.: US 2021/0405621 A1
(43) Pub. Date: Dec. 30, 2021

(54) ELECTRONIC WORKPIECE MANAGEMENT USING MACHINE LEARNING

(71) Applicant: Voxtur Technologies US, Inc., Tampa, FL (US)

(72) Inventors: James E. Albertelli, Atlanta, GA (US); Stacy Mestayer, Clearwater Beach, FL (US); Devlin McConagly, Columbus, NJ (US)

(21) Appl. No.: 17/358,508

(22) Filed: Jun. 25, 2021

Related U.S. Application Data
(60) Provisional application No. 63/044,123, filed on Jun. 25, 2020.

(51) Int. Cl. G05B 19/418; G06N 20/00; G05B 19/408

(52) U.S. Cl. CPC G05B 19/4183; G05B 19/4187; G05B 19/4083; G06N 20/00

(57) ABSTRACT

Methods, systems, and apparatus, including computer programs encoded on a computer storage medium that receives a set of requirements that are associated with a workpiece to be completed. A specification can be generated that specifies a set of components that are required to complete the workpiece. A particular subset of the component sources can be selected to source the set of components that are required to complete the workpiece using one or more machine learning-trained models. The set of sourced components can be obtained from component sources. A particular validation source can be selected to validate at least a portion of the sourced components of the set. At least a portion of the sourced components of the set can be validated. The completed workpiece can be generated using the set of sourced components including the validated portion of the sourced components and provided for output.

### CROSS-REFERENCE TO RELATED APPLICATIONS

This application claims the benefit of U.S. Provisional Pat. App. No. 63/044,123, filed Jun. 25, 2020, which is incorporated by reference.

### TECHNICAL FIELD

This specification relates to the management of workpieces, and one particular implementation relates to creating workpieces using a machine learning-based management system.

### BACKGROUND

Workpieces can be created using computers, machines or other tools. A workpiece can begin as a simple structure, and change form or function during a manufacturing or creation process. For example, an automobile assembly line can begin with a chassis as the workpiece, and as the workpiece traverses the assembly line, parts such as doors, windows, wheels and motors can be attached to produce a completed workpiece. A workpiece can also be an electronic resource that changes form or function in response to various inputs or processes, such as by adding or modifying content components.

### SUMMARY

This specification describes a machine learning-based workpiece management system. More specifically, this specification describes a framework that uses models trained by machine learning to select among sources of components that can be used to automatically and electronically augment the function of a workpiece. While sources for workpiece components can be selected without the use of a machine learning model, including being selected manually, using trained machine learning models to select component sources can reduce the likelihood that a faulty component is included in a workpiece.

In addition, in some cases, adding one or more components to a workpiece is not sufficient to transform the workpiece from an original form into a completed form. A component being applied to the workpiece can be validated, which can include adapting a component to serve a particular purpose in the workpiece, or to confirm that a component satisfies a specification or requirement. A validation source can perform the validation and, where necessary, adaptation processes.

As with component selection, there can be multiple validation sources available to perform the validation function. To ensure a completed workpiece is created correctly, an appropriate validation source must be selected to ensure that components are properly validation and adapted. In some implementations, the completed workpiece is printed on a substrate, or the completed workpiece is transmitted over a network to a receiving device.

Particular embodiments of the subject matter described in this specification can be implemented so as to realize one or more of the following advantages. The techniques described below can be used to generate a completed workpiece using components that have been validated. Using validated components can result in a workpiece that meets a functional specification. In addition, the techniques can use one or more machine learning models to select sources for components that are included in a workpiece. Using machine learning models can result in the selection of sources that are most likely to provide components that results in a workpiece that meets a functional specification.

One aspect features a system that receives a set of requirements that are associated with a workpiece that is to be completed. The system can generate a specification that specifies a set of components that are required to complete the workpiece. The system can select, from a set of component sources that are collectively configured to source the set of components, a particular subset of the component sources to source the set of components that are required to complete the workpiece, using one or more machine learning-trained models. The system can obtain the set of sourced components from the selected, particular subset of the component sources. The system can select, from a set of validation sources that are each capable of validating at least a portion of the sourced components of the set, a particular validation source to validate at least the portion of the sourced components of the set. The system can validate, using the particular validation source, at least a portion of the sourced components of the set. The system can generate the completed workpiece using the set of sourced components including the validated portion of the sourced components. The system can provide for output the completed workpiece.

One or more of the following features can be included. Selecting a particular subset of the component sources can include evaluating component source selection criteria against a plurality of component sources selected from a set of component sources; determining that a component source from the plurality of component sources satisfies the source selection criteria; and adding the component source to a set of potential component sources. The system can select a component source from the set of potential component sources; determine a score that results from evaluating the component source using an evaluation model; and based on determining that the score exceeds the configured threshold, determine that the component source is an appropriate component source. The evaluation model can include at least one trained machined learning model. The trained machine learning model can be a classification model. The trained machine learning model can be trained using features of at least one of the set of components that are required to complete the workpiece. A validation source can adapt at least one portion of the sourced components of the set.

The details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example framework for machine learning-based workpiece management.

FIG. 2 is a flow diagram of an example process for machine learning-based workpiece management.

FIG. 3A is a flow chart depicting the steps of receiving an order for an attorney opinion letter (AOL), placing and receiving an order for title data, and generating the preliminary AOL and assignment to attorney for review.

FIG. 3B is a flow chart depicting the steps associated with curing any title issues found in the preliminary AOL, revising the preliminary AOL as necessary, execution of the preliminary AOL by the attorney, and delivery of the executed preliminary AOL to the settlement agent.

FIG. 4 is a flow chart depicting the steps whereby a settlement agent certifies the requirements in the preliminary AOL have been met, and the final AOL is generated, reviewed, and executed for issuance.

FIGS. 5-28 are screen shots of panes of a user interface from an electronic workpiece management framework.

Like reference numbers and designations in the various drawings indicate like elements.

### DETAILED DESCRIPTION

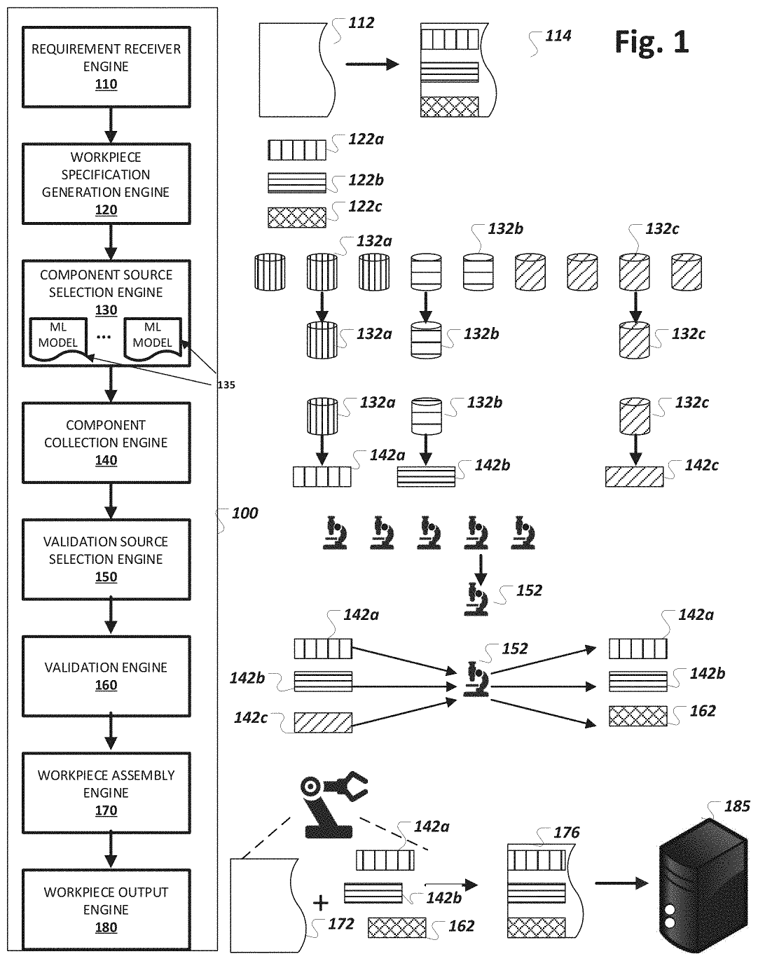

FIG. 1 is a diagram of an example framework 100 for machine learning-based workpiece management. Workpieces can be improved by applying tools, including electronic tools, or machines that change the structure of a workpiece, or components can be added to an incomplete workpiece to produce a final workpiece. A set of requirements can guide the transformation of an initial workpiece to a completed workpiece. For example, if the original workpiece is a car chassis, a requirement might state that a door of a particular form (e.g., oriented for the driver's side) is to be attached at a particular location on the chassis and a second door of a different form (e.g., oriented for the passenger's side) is to be attached at another location on the chassis. If the original workpiece is an electronic resource, e.g, a document, a requirement might state that the workpiece the addition of specific components are necessary to be deemed complete.

In some cases, components can be attached to a workpiece to augment its form or function. As described above, multiple sources for a component might be available, in which case, a component source selection process is required. Choosing an effective source for a component can lead to successful completion of a workpiece; conversely, choosing defective component sources can lead to difficulties, or even failure, when attempting to complete the workpiece. Therefore, the proper selection of component sources is important to the quality of a completed workpiece. For example, dowels from a particular supplier might perform better in the environment for which the completed workpiece is destined, and this performance advantage can be detected using models trained by machine learning. For electronic resources, certain component suppliers can be preferred for various reasons, including an analysis of the quality of previously supplied components.

Before committing to the application of a particular component to a workpiece, it can be advantageous to validate the component. In some cases, multiple validation technologies can be available, and a selection among the technologies is necessary. In addition, if adaptation of a component is necessary during validation, for example, adding a groove to a dowel, only a validation source capable of performing that adaptation should be selected.

With that background, returning to FIG. 1, the machine learning-based workpiece management framework 100 can contain components that generate a complete workpiece. The components can include a requirements receiver engine 110, a workpiece specification generation engine 120, a component source selection engine 130, a component selection engine 140, a validation source selection engine 150, a validation engine 160, a workpiece assembly engine 170 and a workpiece output engine.

The components may also include a printer for printing the completed workpiece, or a network interface for transmitting the completed workpiece over a network. In some implementations, each engine includes one or more computer processors that are configured to execute computer instructions, e.g., a server. In different implementations, an engine is implemented in software.

The requirements receiver engine 110 can accept one or more requirement relating to a final workpiece. For example, requirements can specify that for an initial workpiece 112 to reach completed form 114, three components should be applied. Requirements can also include specific components that will be included in the final workpiece.

A requirement can take various forms such as rules and assertions. For example, a rule might specify that a chassis must have two doors attached. An assertion might state that a door of a particular form should be attached at a specific location. An electronic resource might require the addition of a security component matching specific criteria, or might require review by a source with a particular credential or that satisfies a particular standard. Requirements can also specify the order in which components are applied and validations performed on components.

A requirement can be expressed using any appropriate form. For example, requirements expressed as rules can be expressed using an Extensible Markup Language (XML) format such as RuleML

The workpiece specification generation engine 120 can accept requirements from the requirement receiver engine 110 and determine the components necessary to create the completed workpiece 114. For example, the workpiece specification generation engine 120 can determine that three components 122a, 122b, 122c are necessary to complete the workpiece. Optionally, the workpiece specification generation engine 120 can associate one or more validation criteria with a workpiece specification.

The workpiece specification generation engine can create a workpiece specification in a form such as Extensible Markup Language (XML). The workpiece specification can contain information relating to the components necessary to complete the workpiece, how the components are applied to the workpiece, validations required for the component, and so on.

A component source selection engine 130 can use the workpiece specification to identify the required components, and determine a preferred source for the component. For each specified component, 122a, 122b, 122c, the component source selection engine 130 can determine a preferred source 132a, 132b, 132c from among a collection of available source.

The component source selection engine 130 can use one or more trained machine learning models. Each model can be a classification model, such as a linear regression model, a support vector machine, a decision tree, neural network, and so on, used to determine whether a source is appropriate for a component. The model can be trained on data reflecting prior uses of the component. Features of the model can include data relating to the component (e.g., type, size, etc.), data relating to the workpiece (e.g., type, use, size, etc.), data relating to the sources (components provided, success using component, etc.) and so on. The result of executing the model can be a value indicating a selected source.

The component collection engine 140 can retrieve components 142a, 142b, 142c that meet the source workpiece specifications 122a, 122b, 122c from the selected component sources 132a, 132b, 132c. The component collection engine 140 can use retrieval methods appropriate for the component source. For example, the component collection engine 140 can use a robotic arm to retrieve a physical component from a location, or a data retrieval mechanism, such as a Structured Query Language (SQL) query against a relational database for a data component.

The validation source selection engine 150 can select a validation source 152 from among a group of candidate source. The validation source selection engine 150 can use rules to select the validation source. A rule can be expressed as an assertion that must be true for the rule to be satisfied. For example, a rule might specify, “Can validate component type X” or “Can adapt component type X by performing step Y,” or “Has credential Z.” A validation source 152 can optionally have an associated priority, and a rule might state, “select highest priority validation source that satisfies other rules.” The rules can be evaluated by a rule engine such as RulesML.

The validation engine 160 can apply the selected validation source 152 to the components 142a, 142b, 142c obtained by the component collection engine. The validation source 152 can apply validation criteria to determine whether a component 142a, 142b, 142c is appropriate for the completed workpiece. In some cases where a component 142c is not appropriate for the completed workpiece, the validation source can adapt the component 142c to produce an adapted component 162c suitable for the final workpiece.

The validation criteria can be rules that, when evaluated, determine whether: (i) a component is suitable for the final workpiece, (ii) a component is unsuitable for the final workpiece, or (iii) a component can be adapted to be made appropriate for the final workpiece, and if so, what adaptations are required.

The workpiece assembly engine 170 can accept an initial workpiece 172 and the validated components 142a, 142b, 162, and using the workpiece specification created by the workpiece specification generation engine 120, create the final workpiece by applying the validated components 142a, 142b, 162 to the initial workpiece 172 thereby creating a completed workpiece 176.

The workpiece output engine 180 can provide the completed workpiece 176 for output. For example, for a workpiece that consists of data, the completed workpiece can be provided to a server 185. For a physical workpiece, the completed workpiece can be placed by a robot in a particular physical location. In some implementations, the completed workpiece is printed on a substrate, or the completed workpiece is transmitted over a network to a receiving device.

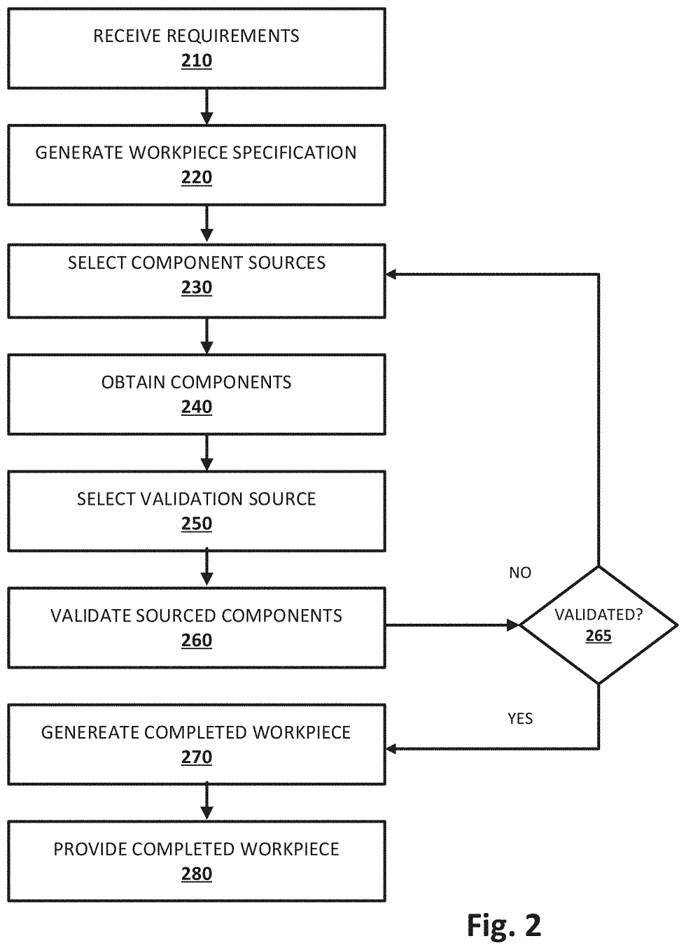

FIG. 2 is a flow diagram of an example process 200 for machine learning-based workpiece management. For convenience, the process 200 will be described as being performed by a machine learning-based workpiece management framework, e.g., the machine learning-based workpiece management framework of FIG. 1, appropriately programmed to perform the process.

In operation 210, the framework receives requirements that specify the form of the completed workpiece. The requirements can be received from a user interacting with user interface presentation data created by the framework and displayed on a user device, from a database, from a file system, and so on.

In operation 220, the framework generates a workpiece specification for a completed workpiece. As described above, the workpiece specification can be

TABLE 1

```
<specification>
  <component>
    <type>
    Component 1
    </type>
    <constraint>
      Constraint 1
    </constraint>
    <constraint>
      Constraint 2
    </constraint>
    . . .
  </component>
  . . .
</specification>
```

expressed as XML. The framework can generate the workpiece specification by combining the specific components that are to be included in the final workpiece with the constraints (received in operation 210) on components. Table 1 shows a skeletal example workpiece specification.

In operation 230, the framework uses one or more machine learning models to select component sources for each component in the workpiece specification. First, the framework determines potential sources for the components. The sources can be determined, for example, from one or more data sources, such as relational database tables, that include data reflecting one or more potential sources for each needed component.

Next, the framework evaluates the source and the component offered by the source against any constraints listed for the components. As describe previously, constraints can be expressed as rules, and the rules can be evaluated against each offered component. Components that do not satisfy all constraints are removed from consideration.

The framework then evaluates each of the remaining components, that is, the components that do satisfy all constraints, and their sources to determine a preferred source. The framework can use one or more machine learning models that have been trained on data reflecting prior uses of components from vendors, including the same or similar components from the same or similar vendors. Features can include the supplying vendor, component type, component instance, date of component acquisition, use of the component, the geographic location where the component will be used, and so on. If the instance of use of the component was not associated with a failure, the instance is labeled as a positive training example; if the component was associated with a failure, the instance is labeled as a negative training example. The framework executes the model (or models) for each remaining component (each with a corresponding source), and the model can produce a value corresponding to the likelihood that the component from the source is appropriate for the use. If that value satisfies a threshold, the framework determines that the source is appropriate.

In cases where multiple sources are deemed appropriate, a tie-breaker can be used. For example, each source can have priority, and the highest priority selected; the source associated with the largest value produced by the model can be selected; or the source can be selected randomly.

If no source is available, the framework can optionally produce an error indication and terminate, or proceed to operation 240 with the components for which sources are available. In the latter case, a validation source can determine whether the workpiece can be completed, as described below.

In operation 240, the framework obtains the components from the component sources selected in operation 230. The method of obtaining the component will vary by component type. For example, a robot arm can gather a physical component from a storage location or an electronic component can be obtained over a network, for example, using HTTP. If at least one component is not available, the framework can produce an error indication and terminate. Alternatively, the framework can attempt to continue without a particular component, optionally also producing an error indication.

In operation 250, the framework selects one or more validation sources. The framework can maintain data, such as one or more database tables, that indicate, for each component or component type and for the completed workpiece, the available validation sources. Optionally, when a component might require adaptation for use in the completed workpiece, the data can include capabilities associated with adapting a workpiece. For example, in the example given above, a validation source can insert a groove in a dowel. In another example, for an electronic workpiece, the validation source might be required to adjust data present in a component, such as a document.

In operation 260, the framework validates the workpiece components. The validation criteria use to validate the components and the completed workpiece can be associated with the workpiece specification. In such cases, the selected validation source can retrieve the validation criteria using the association. Alternatively or in addition, validation criteria can be accessed from other sources, such as databases and file systems, available to the framework.

The selected validation source then executes the validation criteria against the source components. As described previously the validation criteria can be rules, and the framework can execute the rules against the selected components, against data associated with the selected components, or both in combination. The validation is determined to have succeeded if all validation criteria are satisfied and to have failed otherwise. Alternatively, the framework can use a configured threshold to determine whether validation has succeeded. For example, a threshold might state that 90% of criteria must have succeeded for the validation to succeed. Alternatively or in addition, the framework can establish “critical validation criteria” that must all be satisfied, and other criteria must only satisfy the configured threshold. Other approaches to determining whether the criteria are satisfied can also be used.

In cases where the validation criteria specify that a component requires adaptation, the selected validation source attempts to perform the specified adaptation. If an adaptation succeeds, the validation is determined to have succeeded; if an adaptation fails, the validation is determined to have failed. Optionally, the selected validation source can perform multiple attempts to perform the adaptation before determining that the validation did not succeed. Also optionally, certain adaptation can be deemed optional, and failure to perform those adaptations might not result in validation failure. Other approaches can be used to determine whether failed adaptations cause the validation to fail.

In operation 265, the framework determines whether the validations were successful based on the information produced in operation 260 as described above. If the validations were not successful, the framework returns to operation 230; if the validations were successful, the framework proceeds to operation 270.

In operation 270, the framework generates the completed workpiece. The framework generates the workpiece by assembling the selected components according to the workpiece specification. The mechanism by which the framework assembles the workpiece will differ according to the type of workpiece. For example, for a physical workpiece, assembly robots can connect the components according to directions in the workpiece specification. Electronic resources can be generated by a computing device that digitally combines components, for example, by combining components that are included in the workpiece as specified by the workpiece specification.

In operation 280, the framework provides the completed workpiece. Again, the mechanism by which the framework provides the workpiece will differ according to the type of workpiece. For a physical workpiece, a robot or a robotic arm can transport the workpiece to a particular location. For an electronic resource, the framework can transmit the workpiece to a web server, a file system, a database, etc.

In one specific example, a machine learning-based workpiece management framework can be used to create a workpiece such as an attorney opinion letter (AOL) relating to a real-estate title order. An AOL is an attorney work product that contains legal advice or an expression of legal judgment and is based on an attorney's expert knowledge of the relevant law. A title order is a request to complete a title examination, and more specifically to determine whether the title is free of liens, back taxes and other claims. An AOL relating to a title order is an attorney's legal opinion as to whether a title is free of such claims or other defects.

AOLs can be assembled manually, with one or more agents responsible for collecting the data necessary to complete the AOL, in collaboration with other agents, such as qualified attorneys, to review and remedy any deficiencies with the data. However, in many cases, data required to complete an AOL can be obtained from multiple sources, and the selection of an appropriate source can be error-prone. Selecting a source that provides faulty data can result in legal exposure for the party producing an AOL.

In addition, the assembly of an AOL often involves validating and adapting the data necessary to complete an AOL. For example, a form required to produce an AOL might be incomplete, and require a validating agent to supplement the contents of the form. Completing an AOL thus requires one or more “validators” to perform this function, and candidates to serve as validators must be qualified to perform the work, such as possessing a proper license to practice in the relevant jurisdiction. Failure to select appropriate validators can result in a faulty AOL.

Rather than relying on a manually assembled AOL, a machine learning-based workpiece management framework can be used to create an AOL, reducing the likelihood that a faulty AOL is produced. The specification for an AOL relating to a title order can include the data components necessary to determine whether a title is free of claims. The data components can include information relating to liens on the property, legal judgments, building restrictions, mortgages, unpaid homeowner association dues, street and sewer assessments, taxes and levies, etc.

For each data component, multiple sources can exist. For example, primary data sources can include assessors, county recorders, tax collectors and courthouses. In addition, data aggregators, often called “title plants” or “abstract plants” aggregate and index data that may impact the title of real property, and can serve as a source for one or more data components.

As described above, one or more machine learning models can be used to select among the sources for a data component. The machine learning models can be classification models, such as a logistic regression model or a decision tree, trained using historical data relating to the data source. For example, if in one instance, a data source was previously used to provide information relating a particular data type, such as a lien, and the data is determined to be valid, e.g., no lien was subsequently asserted, then the instance can be used as a positive training example. Conversely, if a lien was subsequently asserted, then the instance can be used as a negative training example. More generally, the model can be trained using features that include all data relevant to a title, such as liens, legal judgements, mortgages, unpaid fees, type of property, property location, etc., labeled as positive examples when no subsequent issues (such as a legal action filed against the property) arose and negative examples when subsequent issues did arise.

In some implementations, different models can be used to make different determinations relating to different title issues. For example, some issues, such as unpaid taxes or fees, can be cured by making a payment (possibly including penalties and interest). Other issues, such as building restrictions, easements, and encroachment on another property cannot typically be cured through a payment. One model can be trained using features that related to issues that can be cured with payments, such as mortgages, unpaid fees, etc., and a second model can be trained using features that related to issues that cannot be cured with payments, such as easements.

In some implementations, different models are used for each different type of data source. For example, various models each can be trained separately on examples relating to a particular issue, such as additional mortgages, easements, unpaid taxes, etc.

When a new source for data is required, the candidate sources can be evaluated using the trained machine learning model. Features related to the source, such as the type of data to be produced (e.g., liens, easements, etc.), location of the property, type of property (such as commercial or residential), etc. can be evaluated using the trained machined learning model. The result of the evaluation can be a value, and if the value satisfies a configured threshold, the source can be labeled as a valid source, and if the value does not satisfy the configured threshold, the source can be labeled as invalid. A data source can be selected from among the sources labeled as valid by the machine learning model. If multiple such sources exist, the selection can be made, for example, using the model score (e.g., the source with the highest score is selected), using additional criteria (such as fees) or arbitrarily.

Once a source for a data component of an AOL has been selected, the data component can be obtained from that source. The data can be obtained using a variety of techniques that can depend on the type of source. For example, a title plant might provide an application programming interface (API) through which data can be obtained electronically. In another example, an email might be sent to a primary source, such as a county assessor's office, to request the data component.

A validation source can be selected to validate each data component, and in some cases, the same validation source might validate multiple data components. The validation source can be selected based on requirements that must be satisfied, such as possessing a license to practice in a jurisdiction or another certification or credential, and based on other criteria that are preferably satisfied, such as determinations that past validation actions were found to be correct. The selected validation source must meet all requirements. If multiple validation sources exist that meet all requirements, the sources that satisfies the most criteria or satisfy criteria identified as higher priority, can be selected with ties broken arbitrarily.

Each validation source validates the one or more data components assigned to the source for validation. In some cases, the validation source adapts the data components to enable the data component to pass validation. For example, if a particular document is missing a notarized signature, the validation source can take actions to obtain the notarized signature. In cases where a data component cannot be validated, even after attempts are made to adapt the data component, a new source for the data component can be obtained.

Once all data components have been validated, a completed AOL can be generated based on the validated data components. The data components can be assembled by an electronic tool that combines the components of an AOL according to a document template, or by a user who assembles the components. The completed AOL can then be provided to interested parties such as a settlement agent.

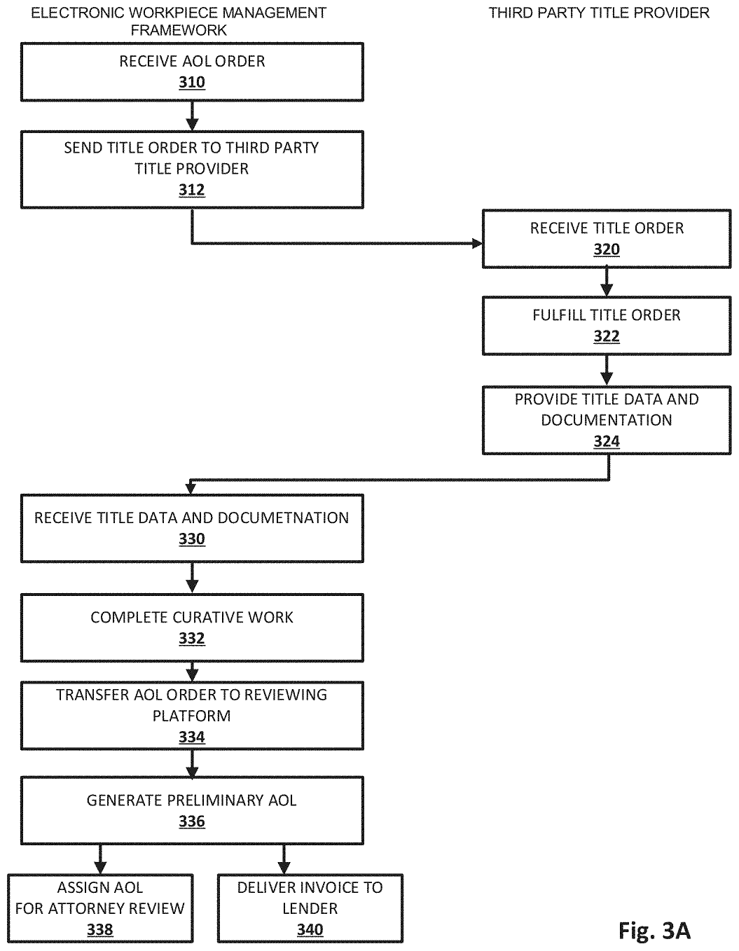

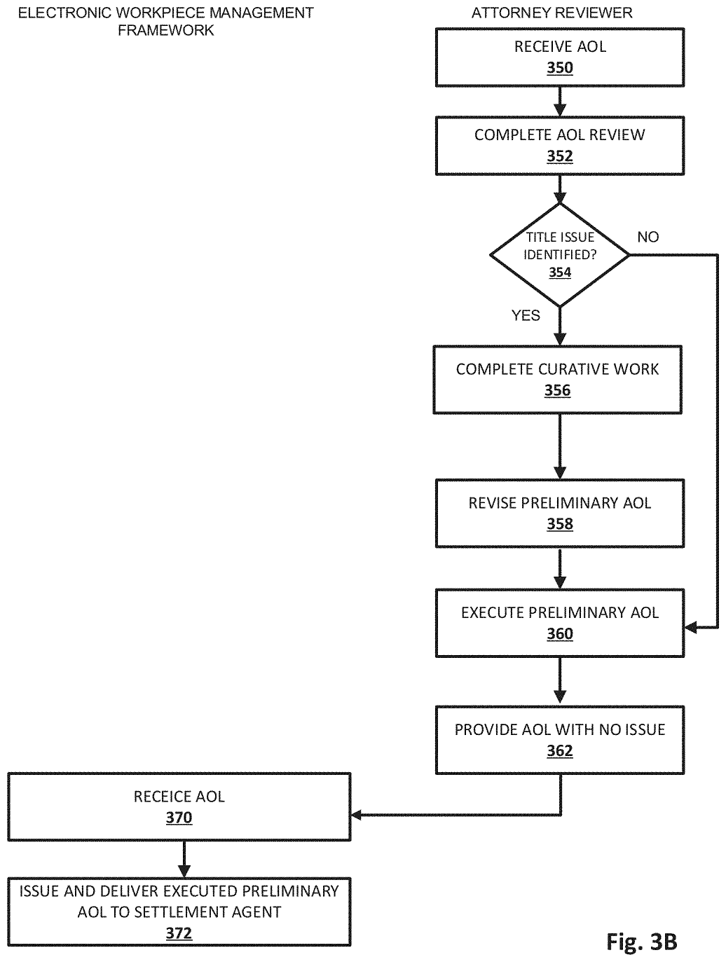

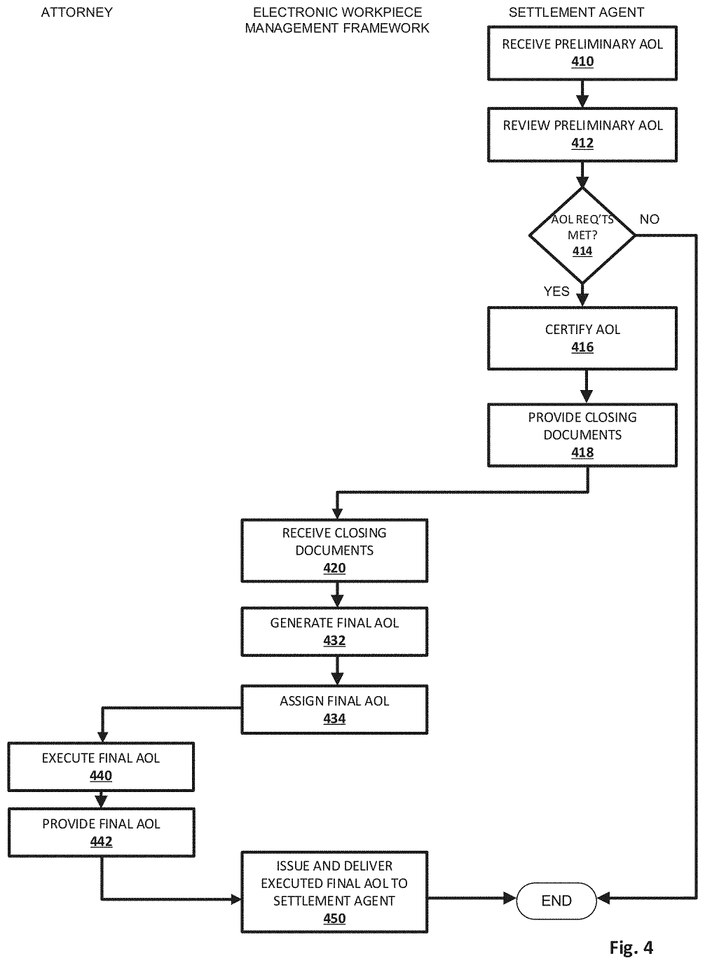

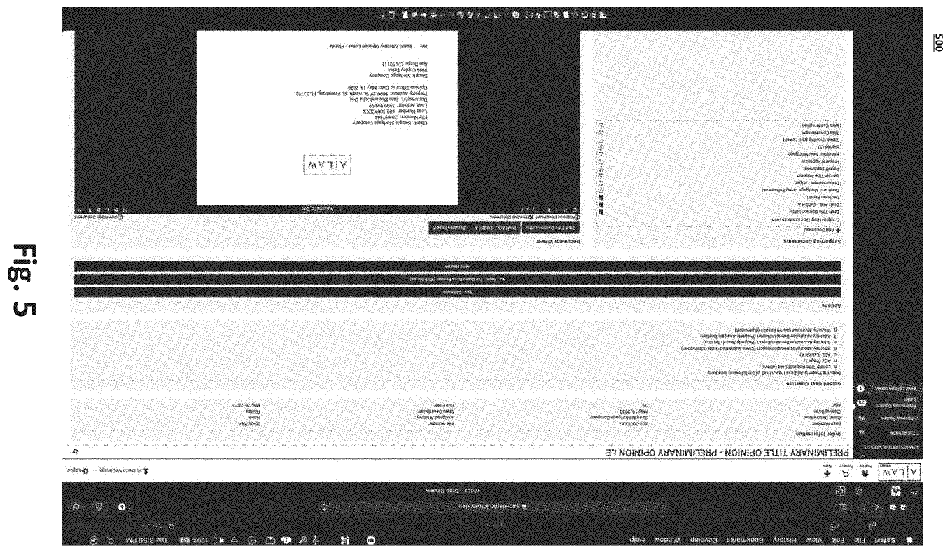

The various methods of the present disclosure are further illustrated in FIGS. 3A, 3B, and 4, while screen shots from the electronic workpiece management framework are provided in FIGS. 5-28.

With reference to FIG. 3A, the steps, for example, as performed by an electronic workpiece management framework, associated with receiving an order for an attorney opinion letter (AOL), which is an example of a workpiece, placing and receiving an order for title data, which is an example of a component, and generating the preliminary AOL and assignment to an attorney, an example of a validation source, for review are depicted. Underlying title documents, such as the vesting deed and existing mortgage, also examples of workpiece components, are just examples of the various supporting documentation that the reviewing attorney will consult while preparing the AOL.

In operation 310 of FIG. 3A, an order for an AOL is initially received by a lawyer, law firm, or legal department. Thereafter, in operation 312, a title order is sent to a third party provider. The title is an example of a component, and the third party provider is an example of a component source, selected, for example using operation 230 of FIG. 2. Once the title data is received (operation 320), an example of obtaining a component (operation 240 in FIG. 2), the process continues. The steps are carried out via user interface presentation data, depicted in FIGS. 5-28, that is created by an electronic workpiece management framework. As explained hereinafter, the electronic workpiece management framework allows the reviewing attorney to easily view any supporting title data and documentation along with the draft of the AOL. The third party title provider, through interactions with user interface presentation data provided by the electronic workpiece management framework, fulfills the title order (operation 322) and provides the title data and documentation (operation 324) to the electronic workpiece management system.

FIG. 3A further illustrates the steps of receiving the title data and documentation (operation 330) from the third party title provider, carrying out any title curative work (operation 322) needed to proceed with the generation of the preliminary AOL, transferring (operation 334) the order information and title data and documentation to a reviewing component of the electronic workpiece management framework, and generating the preliminary AOL (operation 336). In the final step of FIG. 3A, the preliminary AOL is assigned to the attorney who conducts a review within the review platform (operation 338), and the invoice is delivered to the lender (340). The attorney can be an example of a validation source selected using operation 250 of FIG. 2, and the attorney review is an example of validating a sourced component as in operation 260 of FIG. 2.

Once the attorney review, an example of a selected validation source of the preliminary AOL is completed, the process of curing any title issues and revising the preliminary AOL is depicted in FIG. 3B. An attorney reviewer receives the AOL (operation 350) and completes the AOL review (operation 352) by interacting with user interface presentation data provided by the electronic workpiece management framework. In operation 354, a decision is made as to whether any title issues have been identified in the review of the preliminary AOL. If not, the attorney executes the preliminary AOL (operation 360) and provides it (operation 362) to the electronic workpiece management framework, where it is received (operation 370) and delivered to the settlement agent (operation 372). Otherwise, any needed curative work, examples of adaptations performed by validation sources described previously, is carried out (operation 356) and the preliminary AOL is revised accordingly (358). The revised preliminary AOL is then executed by the attorney (operation 360) and provided (operation 362) to the electronic workpiece management framework.

In the final process depicted in FIG. 4, the settlement agent receives the AOL (operation 410) and reviews it (operation 412). The settlement agent, another example of a validation sources, determines (operation 414) whether the requirements contained in the preliminary AOL have been met. If the requirements have not been met, the process ends. In this example, no adaptation is performed by the settlement agent acting as a validation source. Otherwise, if the requirements in the preliminary AOL have been met, the AOL is certified (operation 416), and the final closing documents are provided to the electronic workpiece management framework (operation 418).

In operation 420, the electronic workpiece management framework receives the closing documents. The electronic workpiece management framework generates the final AOL (operation 432 and assigns it to an attorney for review and execution (operation 434). The attorney, a further example of a validator, then reviews and executes the final AOL (operation 440) using user interface presentation data provided by the electronic workpiece management framework and provides the final AOL (operation 442), an example of generating a completed workpiece (operation 270 of FIG. 2), to the electronic workpiece management framework. The final AOL is then sent to the settlement agent for delivery to the lender (operation 450), which is an example of providing a completed workpiece (operation 280 of FIG. 2).

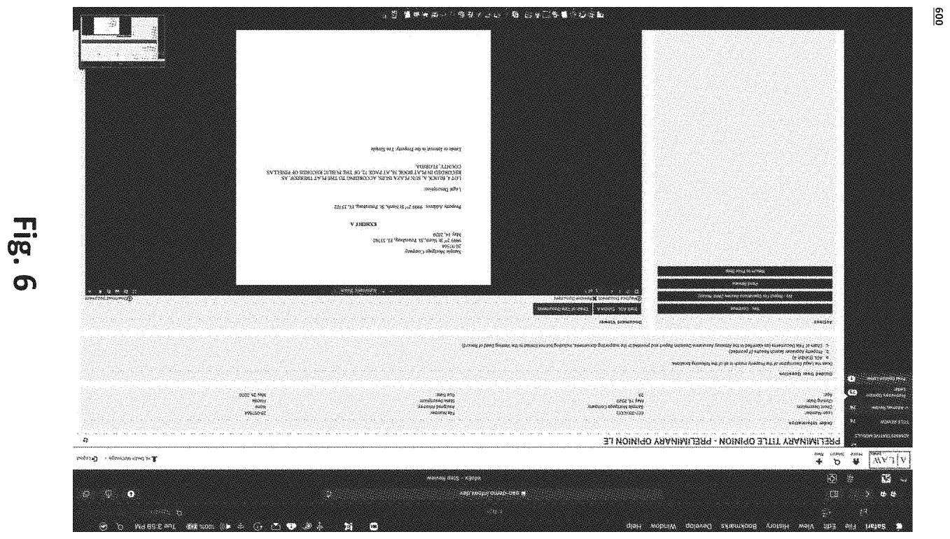

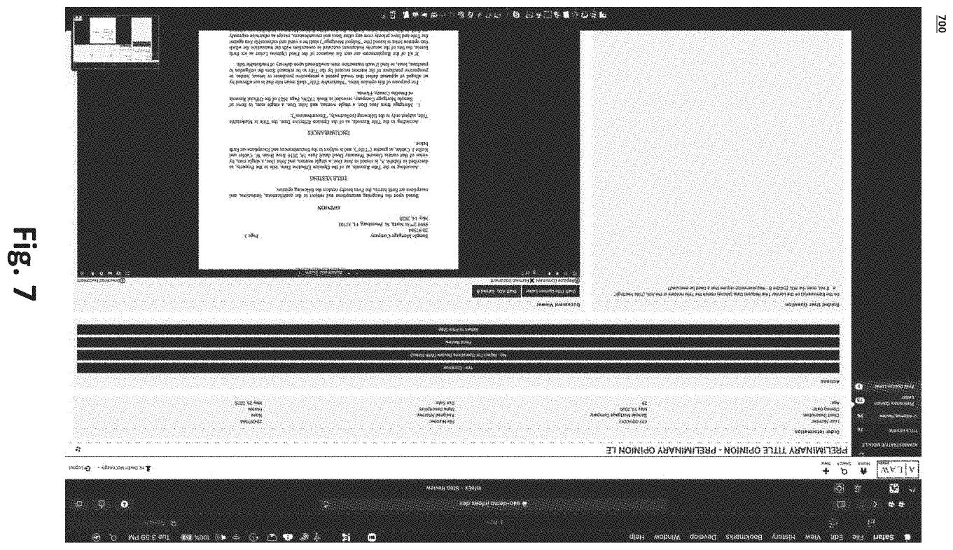

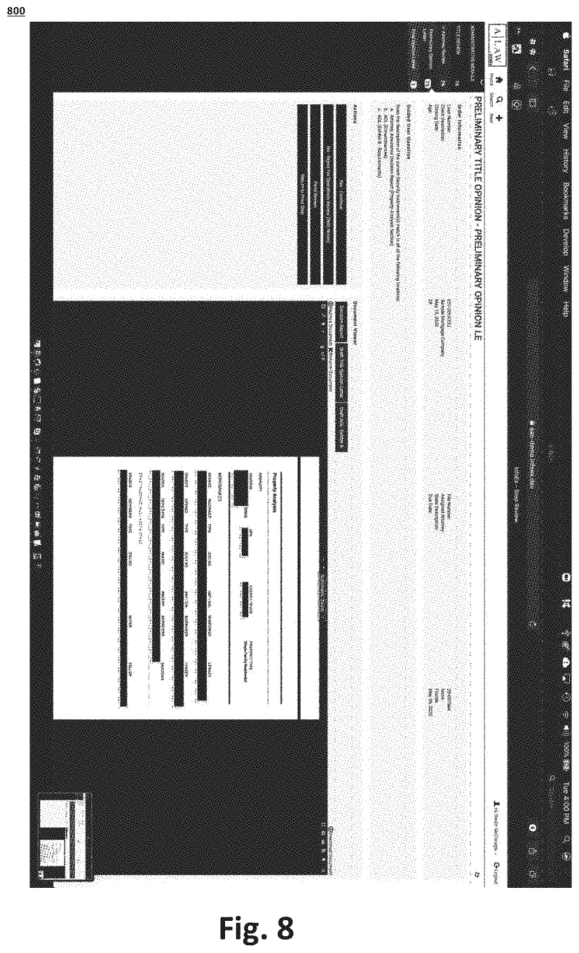

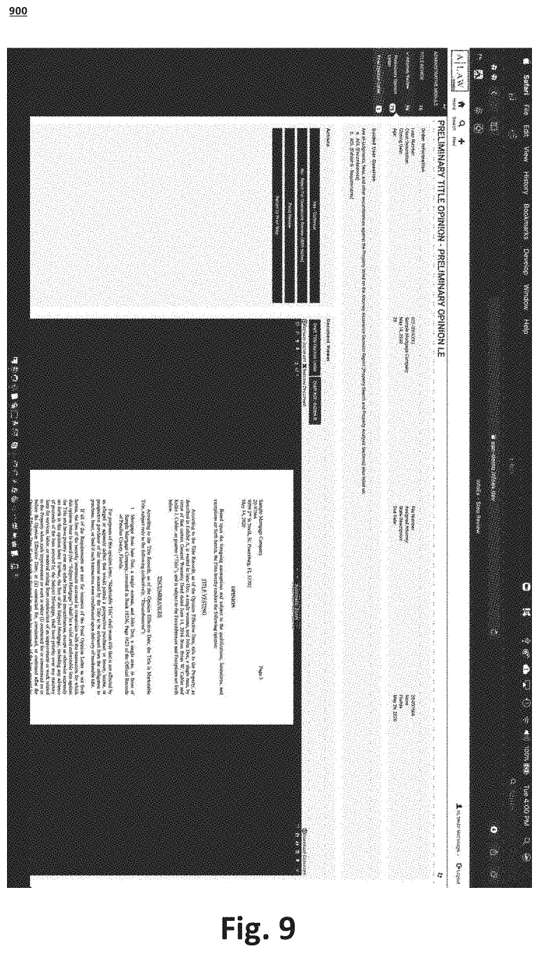

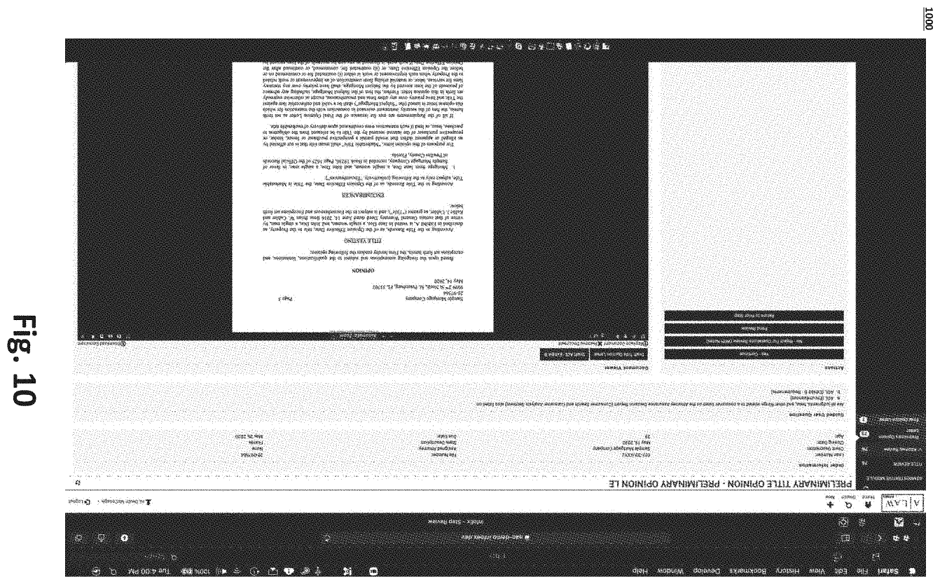

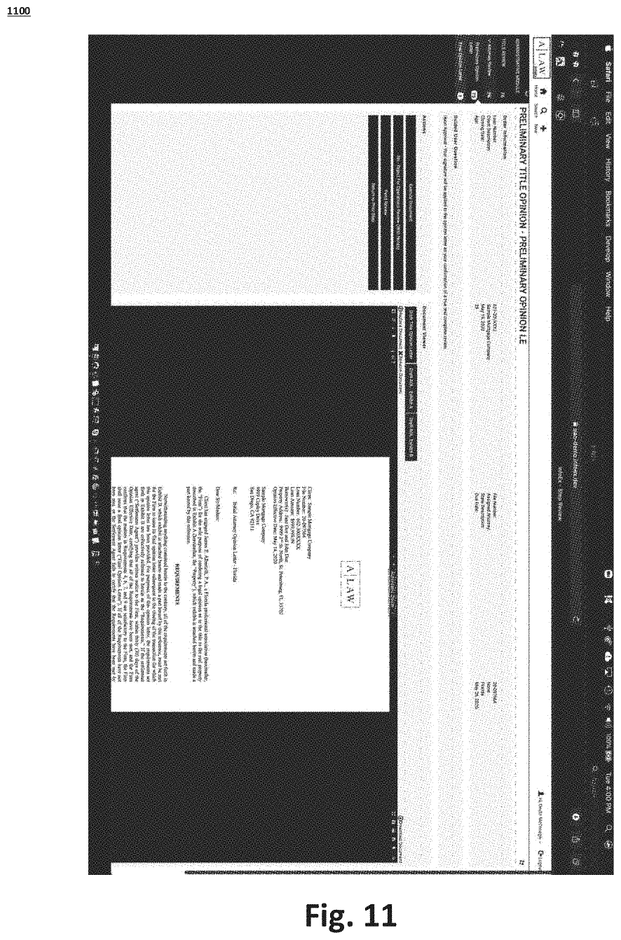

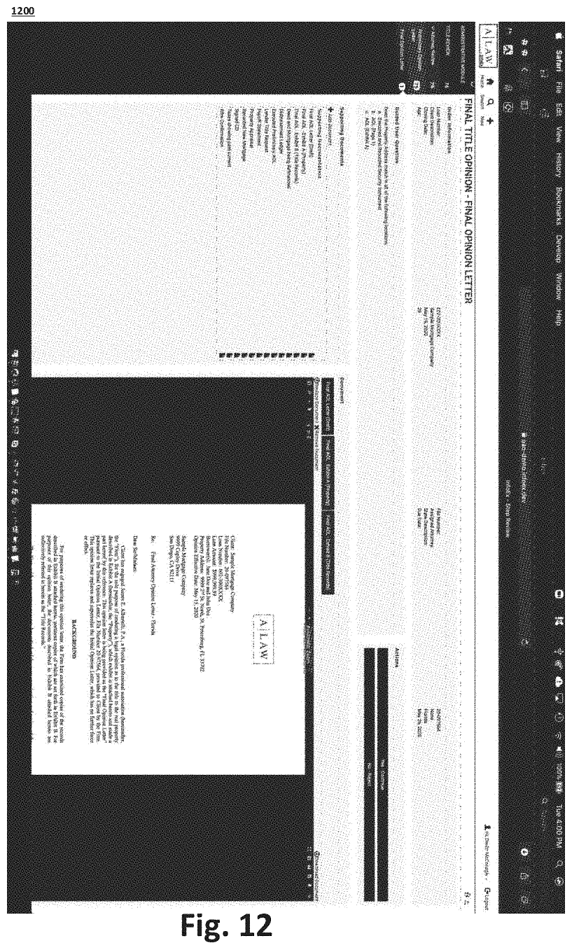

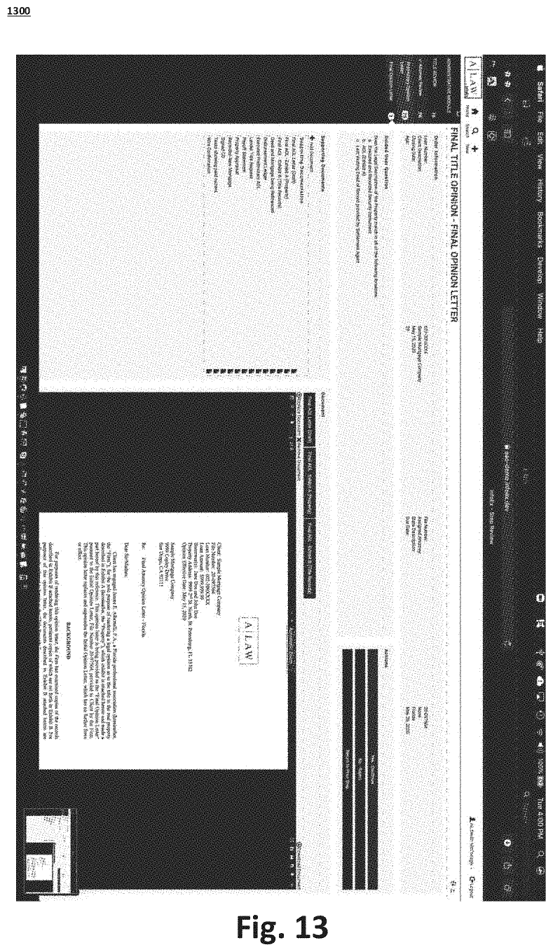

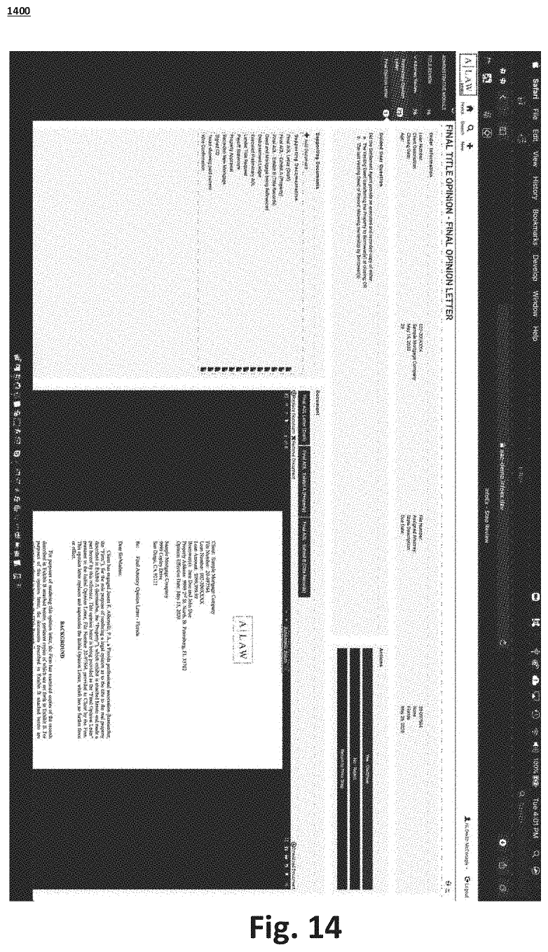

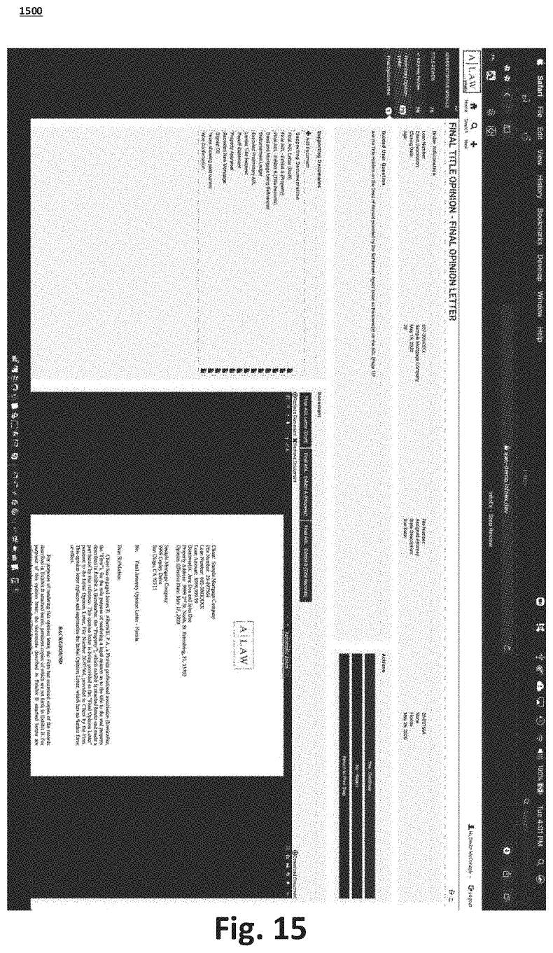

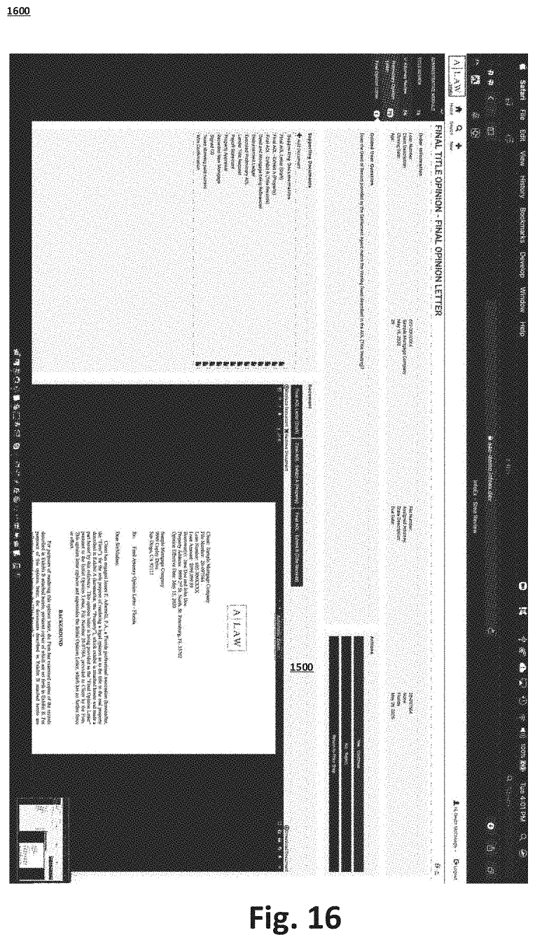

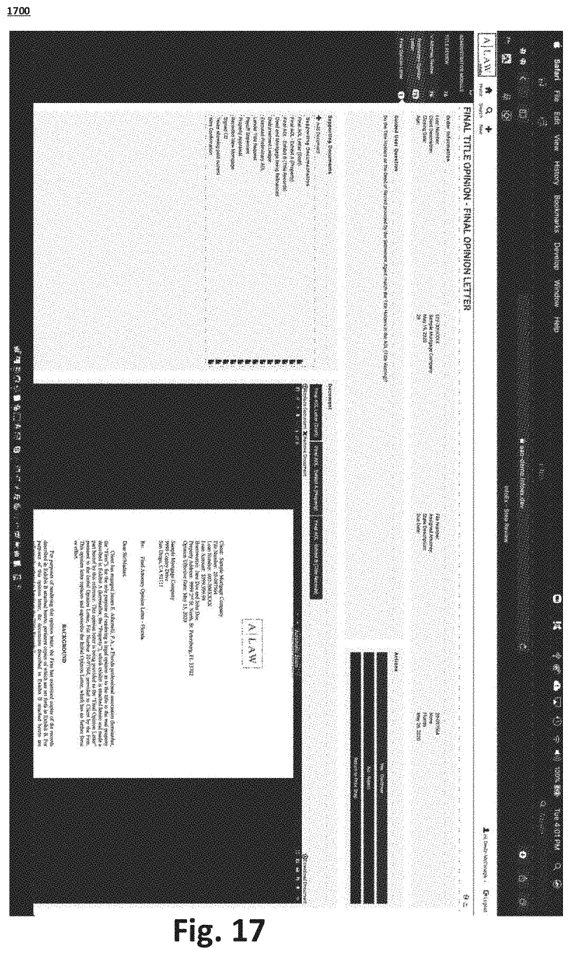

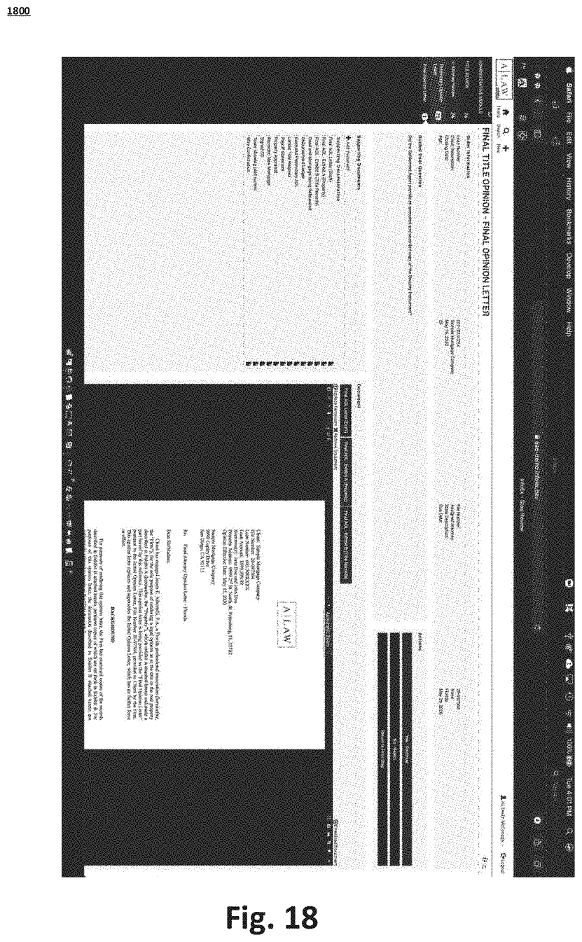

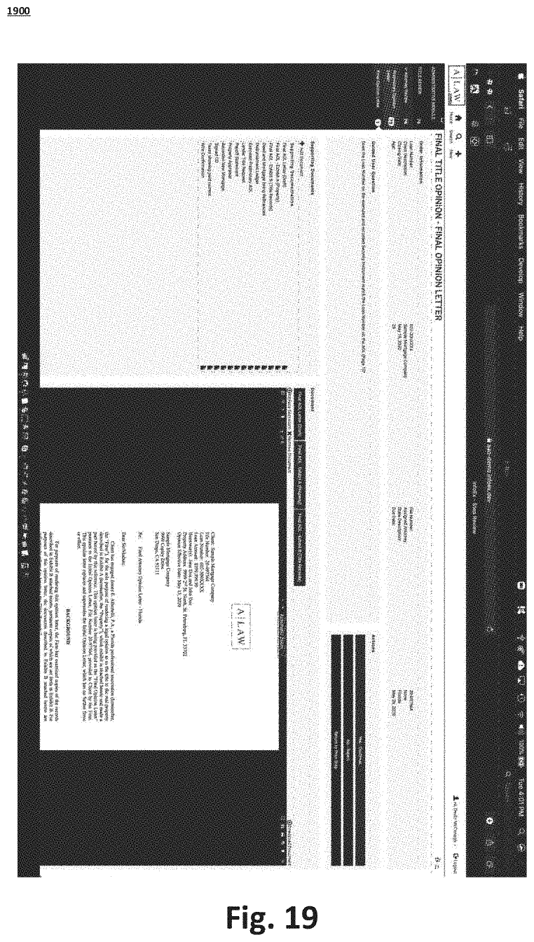

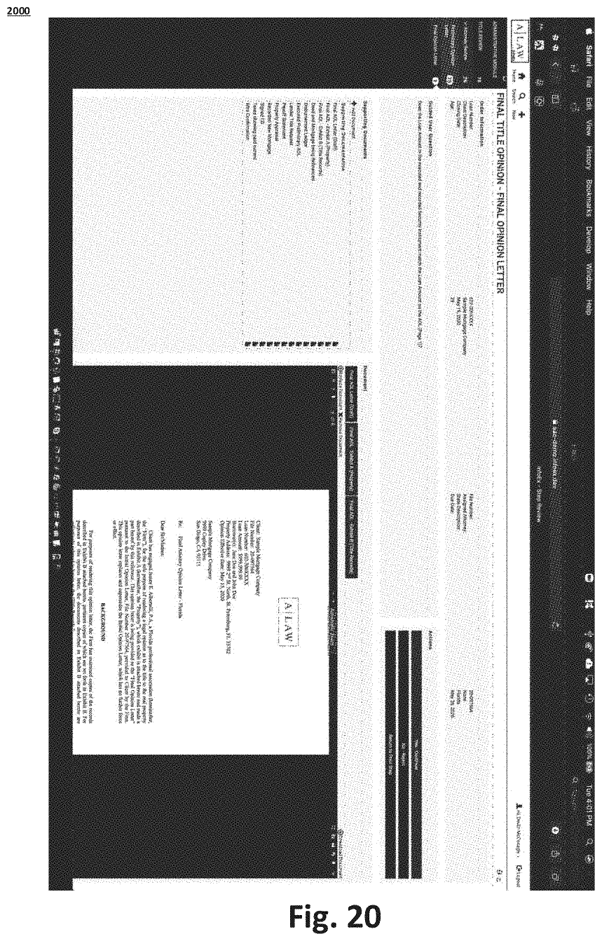

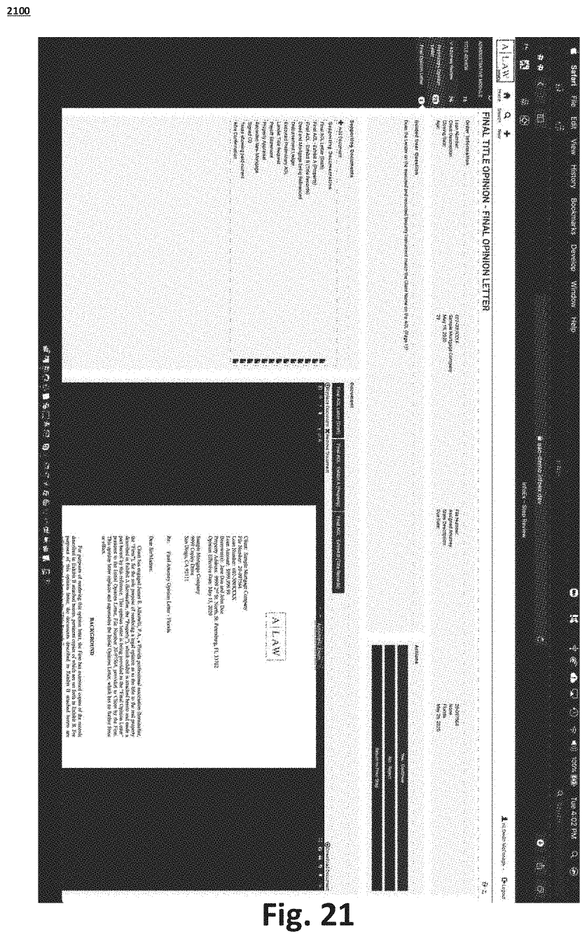

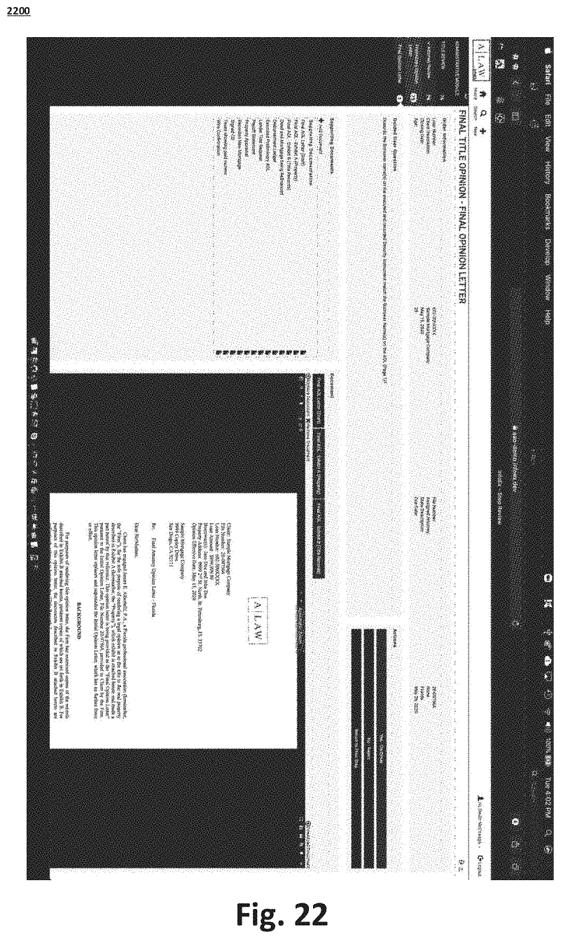

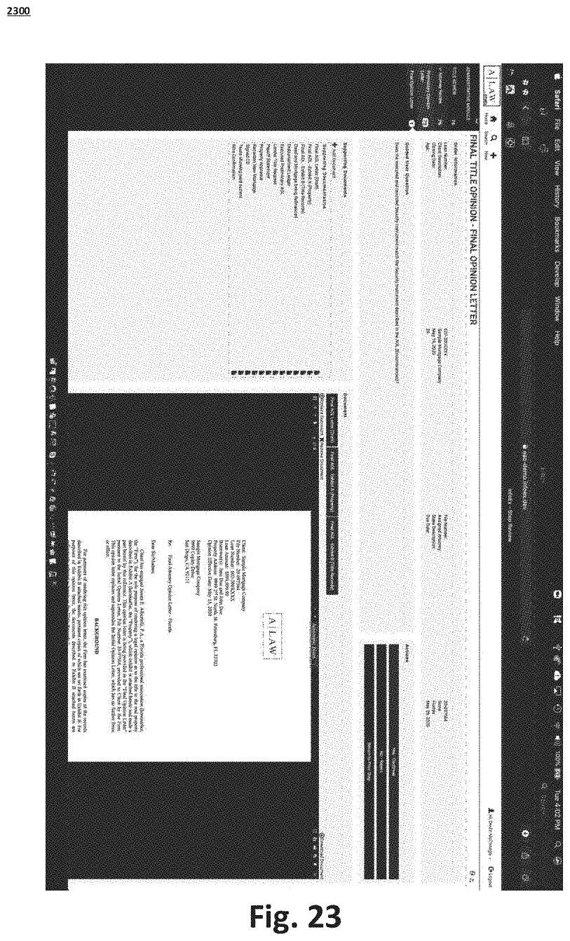

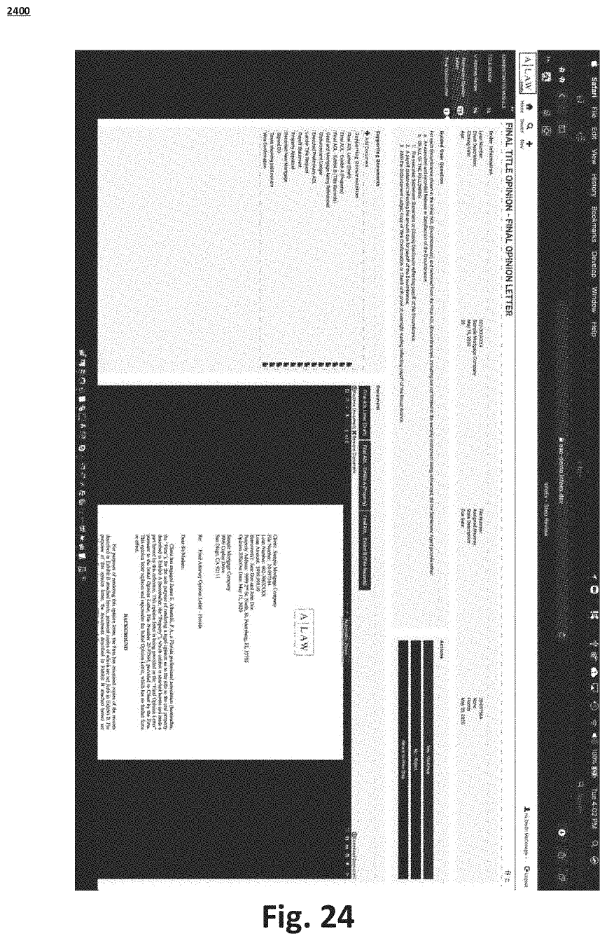

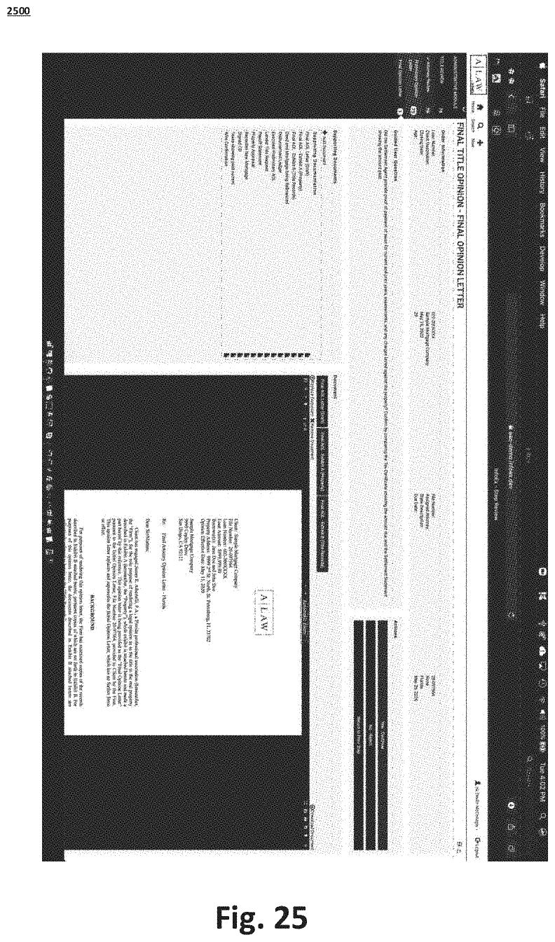

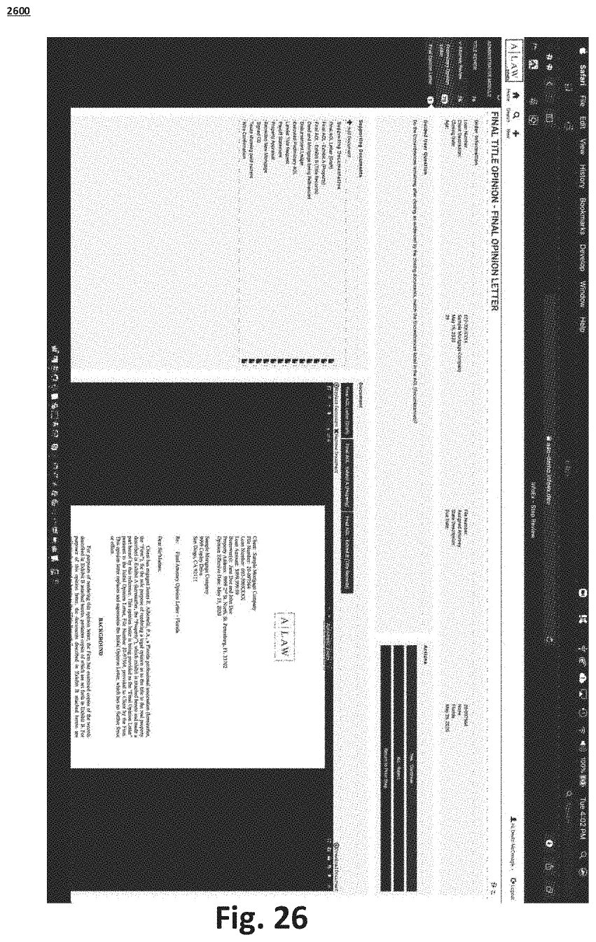

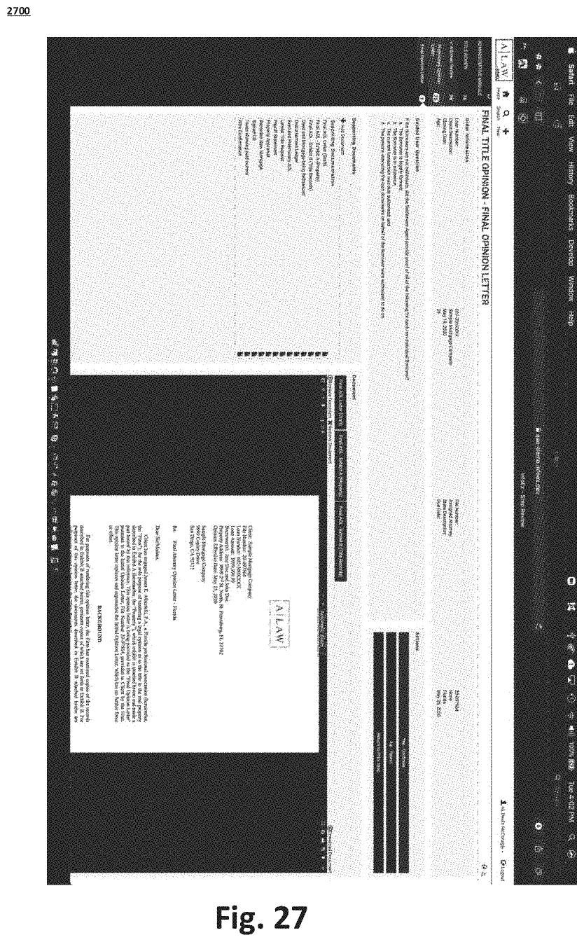

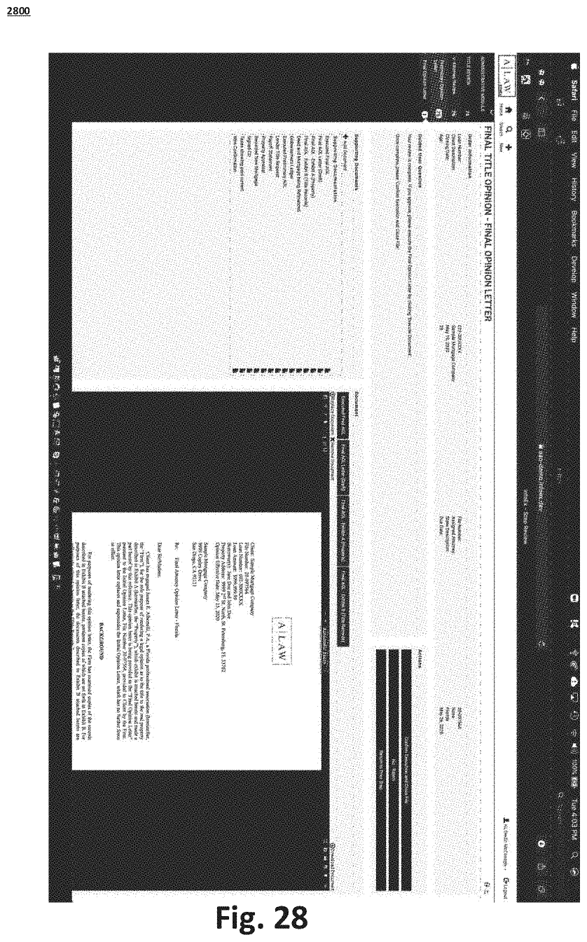

Screen shots of an example user interface generated by an electronic workpiece management framework and depicting the attorney review and quality control process are provided in FIGS. 5-28. In particular, once the supporting data and documentation are uploaded into the electronic workpiece management framework and a preliminary AOL is generated, the attorney has the ability to review any of the supporting data and documentation alongside the AOL. Thereafter, the reviewing attorney is guided through a number of different panels specific to the preliminary AOL and final AOL. FIG. 5 shows a user interface panel 500 in which the attorney can confirm that the property address listed in the preliminary AOL matches the property address listed on the order for the AOL and the title documentation. FIG. 6 shows a user interface panel 600 in which the attorney can confirm that the legal description of the subject property listed in the preliminary AOL matches the legal description of the subject property in the title documentation. FIG. 7 shows a user interface panel 700 in which the attorney can confirm that the borrower(s) listed on the order for the AOL matches the title holder(s) listed in the vesting deed. FIG. 8 shows a user interface panel 800 in which the attorney can confirm that the description of the security instrument in the preliminary AOL matches the description of the security instrument in the title documentation. FIG. 9 shows a user interface panel 900 in which the attorney can confirm that all judgments, liens, and other encumbrances affecting the subject property as listed in the title documentation are also listed in the preliminary AOL. FIG. 10 shows a user interface panel 1000 in which the attorney can confirm that all judgments, liens, and other filings related to a consumer listed in the title documentation are also listed in the preliminary AOL. FIG. 11 shows a user interface panel 1100 in which the attorney is notified that his/her signature will be applied to the preliminary AOL confirming that the review is complete and accurate. Once the settlement agent certifies that the closing has been completed and that the requirements in the preliminary AOL have been met, the draft final AOL can be generated in the electronic workpiece management framework where the attorney has the ability to review the final AOL and any of the supporting documentation. Again, the framework guides the reviewing attorney through a number of user interface panels generated by the electronic workpiece management framework. FIG. 12 shows a user interface panel 1200 in which the attorney can confirm that the property address listed in the final AOL matches the property address listed in the recorded security instrument. FIG. 13 shows a user interface panel 1300 in which the attorney can confirm that the legal description of the subject property listed in the final AOL matches the legal description of the subject property in the vesting deed and the recorded security instrument. FIG. 14 shows a user interface panel 1400 in which the attorney can confirm that the settlement agent provided an executed and recorded copy of the vesting deed showing ownership of the subject property by the borrower(s). FIG. 15 shows a user interface panel 1500 in which the attorney can confirm that the title holders on the deed of record provided by the settlement agent are listed as borrower(s) on the final AOL. FIG. 16 shows a user interface panel 1600 in which the attorney can confirm that the deed of record provided by the settlement agent matches the vesting deed described in the final AOL. FIG. 17 shows a user interface panel 1700 in which the attorney can confirm that the title holders in the deed of record provided by the settlement agent match the title holders in the final AOL. FIG. 18 shows a user interface panel 1800 in which the attorney can confirm that the settlement agent provided an executed and recorded copy of the security instrument. FIG. 19 shows a user interface panel 1900 in which the attorney can confirm that the loan number on the recorded security instrument matches the loan number in the final AOL. FIG. 20 shows a user interface panel 2000 in which the attorney can confirm that the loan amount on the recorded security instrument matches the loan amount in the final AOL. FIG. 21 shows a user interface panel 2100 in which the attorney can confirm that the lender on the recorded security instrument matches the client name in the final AOL. FIG. 22 shows a user interface panel 2200 in which the attorney can confirm that the borrower(s) on the recorded security instrument matches the borrower(s) in the final AOL. FIG. 23 shows a user interface panel 2300 in which the attorney can confirm that the recorded security instrument matches the security instrument described in the final AOL. FIG. 24 shows a user interface panel 2400 in which the attorney can confirm that, for each encumbrance shown in the preliminary AOL and removed from the final AOL, the settlement agent provided a recorded release or satisfaction, or evidence of payoff of the encumbrance. FIG. 25 shows a user interface panel 2500 in which the attorney can confirm that the settlement agent provided proof of payment of taxes for current and prior years, assessments, and any charges levied against the subject property. FIG. 26 shows a user interface panel 2600 in which the attorney can confirm that the encumbrances remaining after closing match the encumbrances listed in the final AOL. FIG. 27 shows a user interface panel 2700 in which the attorney can confirm, for any borrower that is not an individual, that the settlement agent provided proof of legal formation, existence, authorization. FIG. 28 shows a user interface panel 2800 in which the attorney is notified that his/her signature will be applied to the final AOL confirming that the review is complete and accurate. In each of these panels 500-2800, the electronic workpiece management framework gives the attorney access to the applicable portion of the AOL as well as the related supporting data and documentation.

While the present specification has described the electronic workpiece management framework in connection with the review of documents by a human lawyer, in other implementations the same techniques can be applied in connection with the generation, organization and/or review of documents by an automated agent, such as a bot.

In some implementations, the completed workpiece is printed on a substrate, or the completed workpiece is transmitted over a network to a receiving device.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented specialized computer hardware or, in different embodiments, in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software- or hardware-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers. In different implementations, an “engine” includes one or more computer processors that are configured to execute computer instructions, e.g., a server.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
receiving a set of requirements that are associated with a workpiece that is to be completed;
generating a specification that specifies a set of components that are required to complete the workpiece;
selecting, from a set of component sources that are collectively configured to source the set of components, a particular subset of the component sources to source the set of components that are required to complete the workpiece, using one or more machine learning-trained models;
obtaining the set of sourced components from the selected, particular subset of the component sources;
selecting, from a set of validation sources that are each capable of validating at least a portion of the sourced components of the set, a particular validation source to validate the at least the portion of the sourced components of the set;
validating, using the particular validation source, at least the portion of the sourced components of the set;
generating the completed workpiece using the set of sourced components including the validated portion of the sourced components; and
providing, for output, the completed workpiece.

2. The computer-implemented method of claim 1 where selecting a particular subset of the component sources further comprises:
evaluating component source selection criteria against a plurality of component sources selected from the set of component sources;
determining that a component source from the plurality of component sources satisfies the source selection criteria; and
adding the component source to a set of potential component sources.

3. The computer-implemented method of claim 2 further comprises:
selecting a component source from the set of potential component sources;
determining a score that results from evaluating the component source using an evaluation model;
determining that the score exceeds a configured threshold; and
based on determining that the score exceeds the configured threshold, determining that the component source is an appropriate component source.

4. The computer-implemented method of claim 3 where the evaluation model comprises at least one trained machined learning model.

5. The computer-implemented method of claim 4 where the at least one trained machine learning model is a classification model.

6. The computer-implemented method of claim 4 where the at least one trained machine learning model is trained using features of at least one of the set of components that are required to complete the workpiece

7. The computer-implemented method of claim 1 further comprising: adapting, using the particular validation source, at least one portion of the sourced components of the set.

8. A system comprising one or more computers and one or more storage devices storing instructions that when executed by the one or more computers cause the one or more computers to perform operations comprising:
receiving a set of requirements that are associated with a workpiece that is to be completed;
generating a specification that specifies a set of components that are required to complete the workpiece;
selecting, from a set of component sources that are collectively configured to source the set of components, a particular subset of the component sources to source the set of components that are required to complete the workpiece, using one or more machine learning-trained models;
obtaining the set of sourced components from the selected, particular subset of the component sources;
selecting, from a set of validation sources that are each capable of validating at least a portion of the sourced components of the set, a particular validation source to validate the at least the portion of the sourced components of the set;
validating, using the particular validation source, at least the portion of the sourced components of the set;
generating the completed workpiece using the set of sourced components including the validated portion of the sourced components; and
providing, for output, the completed workpiece.

9. The system of claim 8 where selecting a particular subset of the component sources further comprises:
evaluating component source selection criteria against a plurality of component sources selected from the set of component sources;
determining that a component source from the plurality of component sources satisfies the source selection criteria; and
adding the component source to a set of potential component sources.

10. The system of claim 9, the operations further comprising:
selecting a component source from the set of potential component sources;
determining a score that results from evaluating the component source using an evaluation model;
determining that the score exceeds a configured threshold; and
based on determining that the score exceeds the configured threshold, determining that the component source is an appropriate component source.

11. The system claim 10 where the evaluation model comprises at least one trained machined learning model.

12. The system of claim 11 where the at least one trained machine learning model is a classification model.

13. The system of claim 11 where the at least one trained machine learning model is trained using features of at least one of the set of components that are required to complete the workpiece

14. The system of claim 8, the operations further comprising: adapting, using the particular validation source, at least one portion of the sourced components of the set.

15. One or more non-transitory computer-readable storage media storing instructions that when executed by one or more computers cause the one or more computers to perform operations comprising:
receiving a set of requirements that are associated with a workpiece that is to be completed;
generating a specification that specifies a set of components that are required to complete the workpiece;
selecting, from a set of component sources that are collectively configured to source the set of components, a particular subset of the component sources to source the set of components that are required to complete the workpiece, using one or more machine learning-trained models;
obtaining the set of sourced components from the selected, particular subset of the component sources;
selecting, from a set of validation sources that are each capable of validating at least a portion of the sourced components of the set, a particular validation source to validate the at least the portion of the sourced components of the set;
validating, using the particular validation source, at least the portion of the sourced components of the set;
generating the completed workpiece using the set of sourced components including the validated portion of the sourced components; and
providing, for output, the completed workpiece.

16. The one or more non-transitory computer-readable storage media of claim 15 where selecting a particular subset of the component sources further comprises:
evaluating component source selection criteria against a plurality of component sources selected from the set of component sources;
determining that a component source from the plurality of component sources satisfies the source selection criteria; and
adding the component source to a set of potential component sources.

17. The one or more non-transitory computer-readable storage media of claim 16, the operations further comprising:
selecting a component source from the set of potential component sources;
determining a score that results from evaluating the component source using an evaluation model;
determining that the score exceeds a configured threshold; and
based on determining that the score exceeds the configured threshold, determining that the component source is an appropriate component source.

18. The one or more non-transitory computer-readable storage media of claim 17 where the evaluation model comprises at least one trained machined learning model.

19. The one or more non-transitory computer-readable storage media of claim 18 where the at least one trained machine learning model is a classification model.

20. The one or more non-transitory computer-readable storage media of claim 15, the operations further comprising: adapting, using the particular validation source, at least one portion of the sourced components of the set.
